(19) United States
(12) Patent Application Publication
(10) Pub. No.: US 2008/0290203 A1
(43) Pub. Date: Nov. 27, 2008

(54) ELECTROMECHANICAL SEAT BELT RETRACTOR

(75) Inventors: Kenneth H. Kohlndorfer, Roseville, MI (US); Susan A. Richards, Sterling Heights, MI (US); Lawrence M. Refior, Romeo, MI (US); Tammy M. Korona, Clinton Township, MI (US); Gopalakrishnan Doraiswamy, Sterling Heights, MI (US)

Correspondence Address: KEY SAFETY SYSTEMS, INC.;PATENT DEPARTMENT, 5300 ALLEN K BREED HIGHWAY, LAKELAND, FL, 33811-1130, US

(73) Assignee: KEY SAFETY SYSTEMS, INC., Sterling Heights, MI (US)

(21) Appl. No.: 11/753,763

(22) Filed: May 25, 2007

(51) Int. Cl. B60R 22/46

(52) U.S. Cl. 242/374

(57) ABSTRACT

An electromechanical seat belt retractor has a seat belt retractor assembly having a spool rotationally moveable about an axis of rotation for winding and unwinding a seat belt; a motor for selectively rotating the spool; a clutch including an over-clutch driven by the motor through one or more gears; the clutch being coaxially aligned with the axis of rotation of the spool and linearly spaced from the spool; and wherein upon a forward actuation of the motor a clutch plate of the clutch linearly moves to engage the spool coupling to the spool and thereafter rotating the spool about the axis to initiate a winding of the seat belt. After the clutch plate engages the spool a reversal of the motor linearly moves the clutch plate away from the spool disengaging the spool. Preferably the clutch means is a Bendix type clutch assembly. In a preferred embodiment, the clutch plate first engages an over-clutch is fixed in a locking engagement to the spool.

### FIELD OF THE INVENTION

The present invention relates to a seat belt retractor generally. More particularly to seat belt retractors of an electromechanical type which use an electric motor to wind up the seat belt in various situations including when a collision event is imminent to more securely hold the occupant just prior to and during impact.

### BACKGROUND OF THE INVENTION

A seat belt device installed in a vehicle such as an automobile typically has at least a seat belt retractor for winding up a seat belt, a tongue slidably attached to the seat belt, and a buckle to which the tongue can be latched. In the event of an emergency such as a vehicle collision where a large deceleration is exerted on the vehicle while an occupant wears the seat belt in a state that the tongue is latched to the buckle, the seat belt device restrains, thereby protects the occupant.

The seat belt device is provided with a seat belt retractor for winding up the seat belt. The seat belt retractor has a biasing means such as a spiral spring which always biases a spool, on which the seat belt is wound, in the belt-wind up direction. When not used, the seat belt is fully wound on the spool by the biasing force of the biasing means. When used, the seat belt is withdrawn against the biasing force of the biasing means and is worn by the occupant. In the seat belt retractor, a locking mechanism is activated in the event of emergency as mentioned above to stop the rotation of the spool in an unwinding direction, thereby preventing the seat belt from being withdrawn.

A motorized seat belt retractor has a motor to wind up the spool and is commonly referred to as an EMR or electro mechanical retractor. When it is determined that the collision is imminent as well as in other operating situations, the tension on a seat belt is increased by increasing the driving force of a motor to wind up the seat belt, thereby increasing the restraint force of the occupant and, when the vehicle collision is actually detected, an additional pretensioner can be actuated whereby the seat belt is rapidly wound up, thereby further increasing the restraint force for the occupant.

A variety of EMR type seat belt retractors are commercially sold, but in every type sold, in the event no collision occurs the predetermined or otherwise tightening of the seat belt must either be reversed or otherwise disengaged.

Ideally, seat belt retractors need to be sophisticated in performance and yet simple and reliable in design. The coupling of an electric motor to the seat belt retractor provides opportunities to improve the performance of the seat belt system to better secure the occupant prior to a collision but it has also created additional cost, complexity issues that need to be solved.

The present invention provides a novel way to insure high quality performance while improving reliability and reducing the cost to manufacture the device.

The invention as described herein provides a novel way to engage and disengage the various electro mechanical elements so that the belt wind up forces are safely and efficiently transmitted from the motor more directly to the spool while bypassing the more fragile components in the retractor assembly. The invention also further provides a way to simply disengage the motor from the mechanism such that the retractor assembly can function virtually independent of the motor during normal driving conditions.

### SUMMARY OF THE INVENTION

An electromechanical seat belt retractor has a seat belt retractor assembly having a spool rotationally moveable about an axis of rotation for winding and unwinding a seat belt; a motor for selectively rotating the spool; a clutch means driven by the motor through one or more gears; the clutch means being coaxially aligned with the axis of rotation of the spool and linearly spaced from the spool; and wherein upon a forward actuation of the motor a clutch plate of the clutch means linearly moves to engage the spool coupling to the spool to the motor and thereafter rotating the spool about the axis to initiate a winding of the seat belt. After the clutch plate engages the spool a reversal of the motor linearly moves the clutch plate away from the spool disengaging the spool. The clutch plate can directly engage the spool or preferably indirectly engage the spool using an intermediate over-clutch attached to an end of the spool to cause a direct locking engagement with the spool. In the illustrated embodiment, the clutch means is a Bendix type clutch assembly. In the illustrated embodiment, the clutch plate first linearly moves to engage an over-clutch pre-attached to the spool causing a locking engagement of the spool.

### BRIEF DESCRIPTION OF THE DRAWINGS

The invention will be described by way of example and with reference to the accompanying drawings in which:

FIG. 1 is a perspective view of the electromechanical retractor (EMR) assembly according to the present invention.

FIG.'S 2A and 2B are exploded views of the electromechanical retractor assembly take from FIG. 1 showing the various components of the assembly.

FIG. 3 is a cross sectional view of the electromechanical retractor assembly showing the linearly moveable clutch means in the pre-engagement location.

FIG. 4A is an enlarged cross sectional view of the electromechanical retractor assembly showing the linearly moveable clutch means prior to engaging an over clutch.

FIG. 4B is a cross sectional view of linearly moveable clutch plate engaged to the over clutch wherein the clutch plate is pushed into contact with an end of the spool containing a locking means comprising a plurality of spring loaded balls adapted to lock into recesses in an end of the over clutch.

FIG. 5A is an enlarged exploded view of the spool and clutch mechanism.

FIG. 5B is a second enlarged exploded view of the spool and clutch mechanism from another perspective showing the other side of the various components.

FIG. 6 is a perspective view of the clutch mechanism assembly with the one cover removed to show the components.

FIG.'S 7A and 7B show the spool and clutch assembly, FIG. 7A showing the rotation to engage the overclutch and spool, while FIG. 7B shows the opposite rotation causing a disengagement of the clutch from the over clutch and spool.

FIG. 8 is a perspective view of the seat belt assembly according to the present invention showing a pretensioner assembly attached to a side of the frame.

FIG. 9A is a cross sectional view of the seat belt assembly taken along lines 9A-9A of FIG. 8.

FIG. 9B is the cross sectional view of FIG. 9A after the pretensioner assembly has been activated demonstrating an emergency crash scenario.

### DETAILED DESCRIPTION OF THE INVENTION

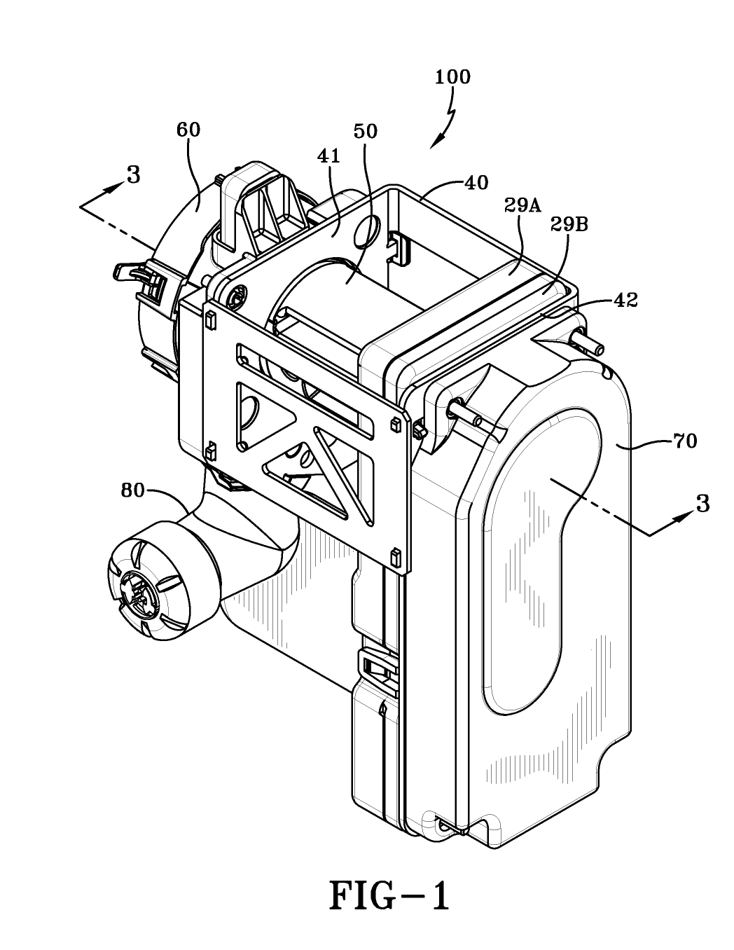

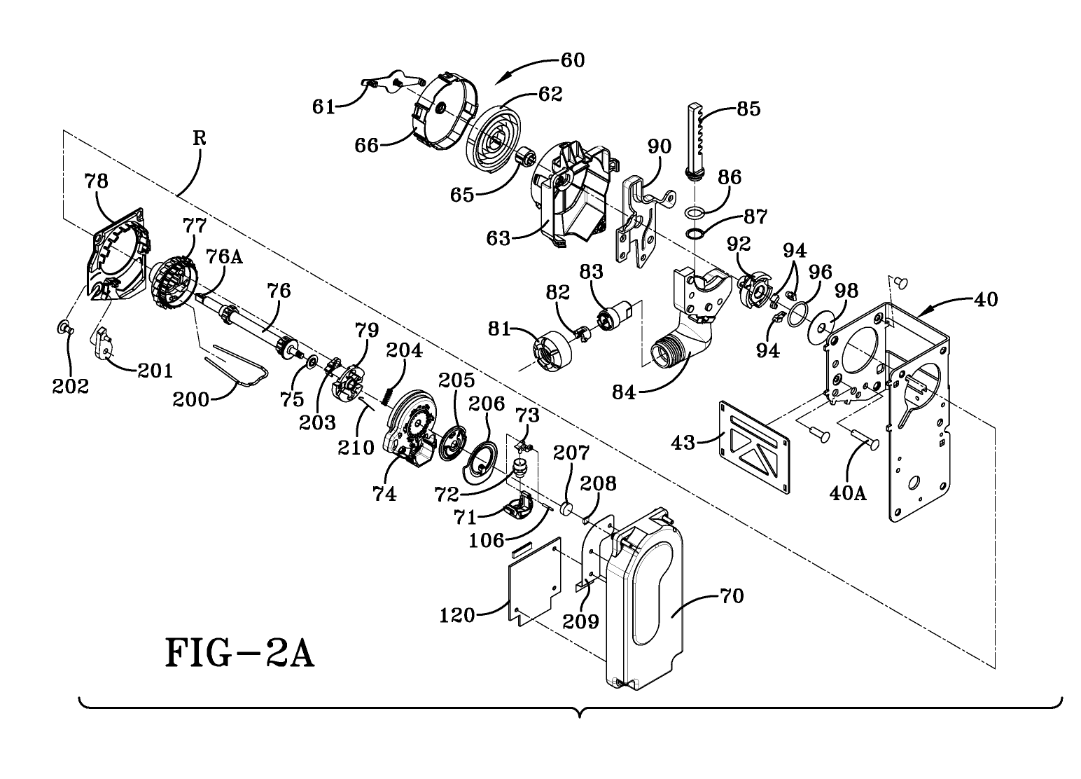

With reference to FIG. 1, 2A and 2B. FIG. 1 is a perspective view of an electromechanical seat belt retractor 100 according to the present invention is illustrated. The seat belt retractor 100 as shown has a frame 40 which holds a spool 50 between two opposing sides 41, 42 of the frame 40. Attached to the left hand side of the seat belt retractor assembly 100 is a spring biasing assembly 60 which includes a spirally wound pretensioned spring 62 that provides a bias to the seat belt retractor assembly 100 so that the seat belt (not shown) is always biased in the wound up position. As a user operates the seat belt by pulling on the seat belt, the spool 50 rotates and the seat belt is pulled outwardly increasing the tension on the biasing spring 62. Interposed between the spring biasing assembly 60 and shown also on the lower left hand side 41 of the frame 40 is a pretensioner mechanism 80 which in an emergency crash situation can be fired to activate a rapid pretensioning of the spool 50 causing an immediate take up of the seat belt to more securely hold the occupant.

With reference to the right hand side 42 of the frame 40 of the seat belt retractor assembly 100 an outer dust cover 70 is illustrated which covers a spool locking mechanism of known construction that includes an inertial vehicle sensor and web sensor. The locking mechanism includes lockcup 74 that is rotationally supported on an axle such as a portion of the torsion bar. The lockcup 74 supports a housing 71 which supports a moveable weight sensor or mass 72. The locking mechanism includes a locking pawl 73 rotationally mated with a frame side 42 and a lock wheel—as well as other known components that will provide a mechanical path in which the spool 50 can be locked from further rotation outwardly during periods of high vehicle deceleration and/or periods of rapid protraction of the seat belt from the spool. Interposed between the dust cover 70 and the seat belt retractor frame 40 is a two piece clutch housing cover 29A and 29B which contains a clutch means 10 that can be activated by an electric motor 30 as shown in FIG. 2B.

With further reference to FIGS. 2A and 2B, an exploded view of the entire seat belt retractor assembly 100 is illustrated showing the various components that are used to make the entire assembly. With reference to the upper portion of FIG. 2A the spring biasing assembly 60 as illustrated, a spirally wound biasing spring 62 is pre-wound using a prewinding clip 61 and is attached to the spring cover 66 which is connected to the housing 63 in such a fashion that a biasing force is always applied to the spool 50 after the prewinding clip 61 is removed. The spring 60 is connected to one end 76A of a torsion bar 76 by a spring arbor 65 in a known manner. The entire assembly 60 is then mounted and attached to the frame 40. In between the spring biasing assembly 60 and the frame 40 is a clutch bracket 90 as illustrated which holds a clutch housing 92, a locking pawl 94 an o-ring 96 and a retainer washer 98. As further illustrated a pretensioner mechanism 80 including a cap 81, a shorting clip 82, a gas generating device 83 and a manifold 84 is illustrated. The manifold 84 houses a rack 85, an o-ring 86 and a push retainer 87 that are connected to the frame 40 of the seat belt retractor assembly 100 in such a way that during a crash, the gas generating device 83 can be ignited and the rack 85 will engage the clutch housing 92 which drives end 76A of the torsion bar 76 causing a rapid rotation of the spool 50 thus pretensioning the attached seat belt.

As shown in the lower portion of FIG. 2A, on the left hand side of the retractor frame 40 is a mechanical bushing 78, a toothed pilot wheel 77, the torsion bar 76 which extends on one side through a pilot wheel and extends on another side to the lockcup 74. A thrust washer 75 is received on the torsion bar an inertia disk 79 which is part of the weight sensor 72, a calibration spring 210, a return spring 204, a blockout cam 206 and an activation disk 105 vehicle sensor pawl 73, a housing 101 connected by a pivot pin 106 as illustrated. A pin 202, lockbar 201 and DRL wire 200 are shown along with a web sensor pawl 203, a calibration spring 210 and return spring 204, an activation disk 205, blockout cam 206 and other miscellaneous elements 207, 208 and 209 are shown, some of which are optional accessories not required in using the present invention per se, but are illustrated to show the entire retractor assembly 100. These mechanisms are commonly used in mechanical seat belt retractors and are understood by those of ordinary skill in the art to provide a way of locking the spool 50 during a rapid seat belt protraction and rapid vehicle deceleration which would cause the web sensor to activate or the sensor weight 72 to tip causing the sensor pawl 73 to pivot which initiates the locking of the spool 50 which is not free to rotate relative to the torsion bar 76 and any applied force on the torsion bar 76 could be absorbed thereby.

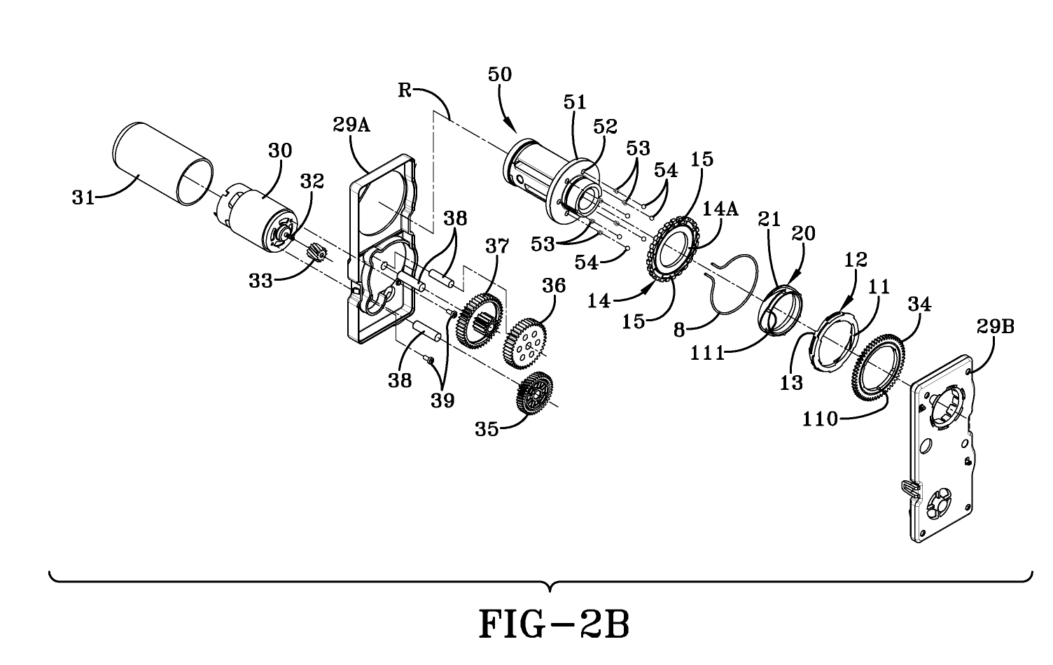

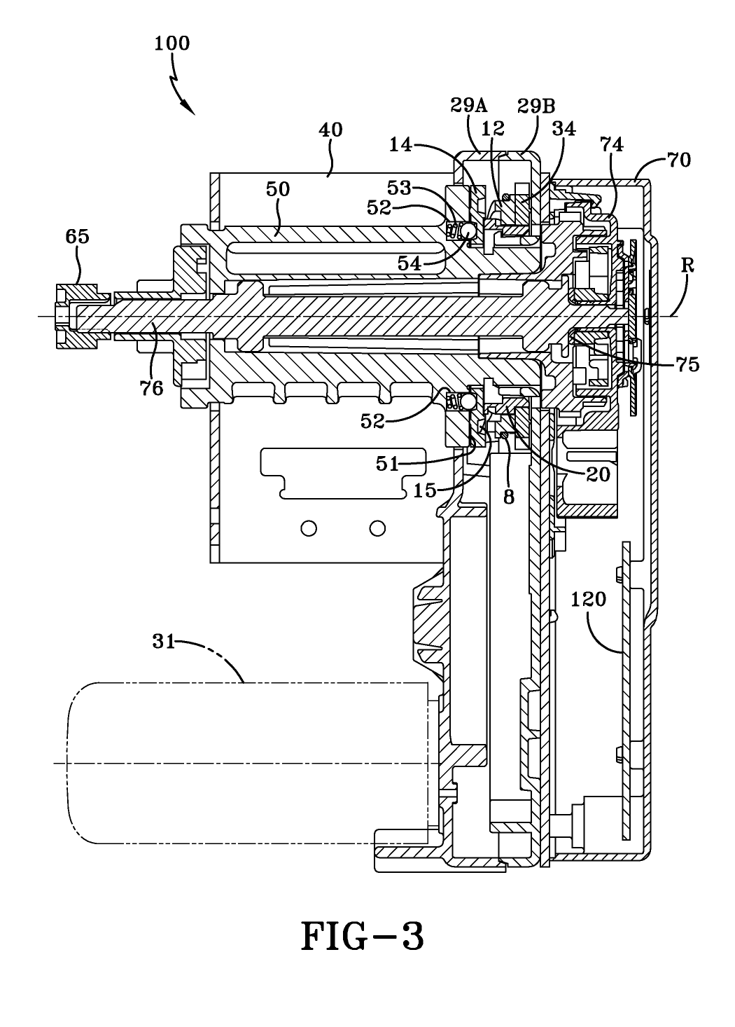

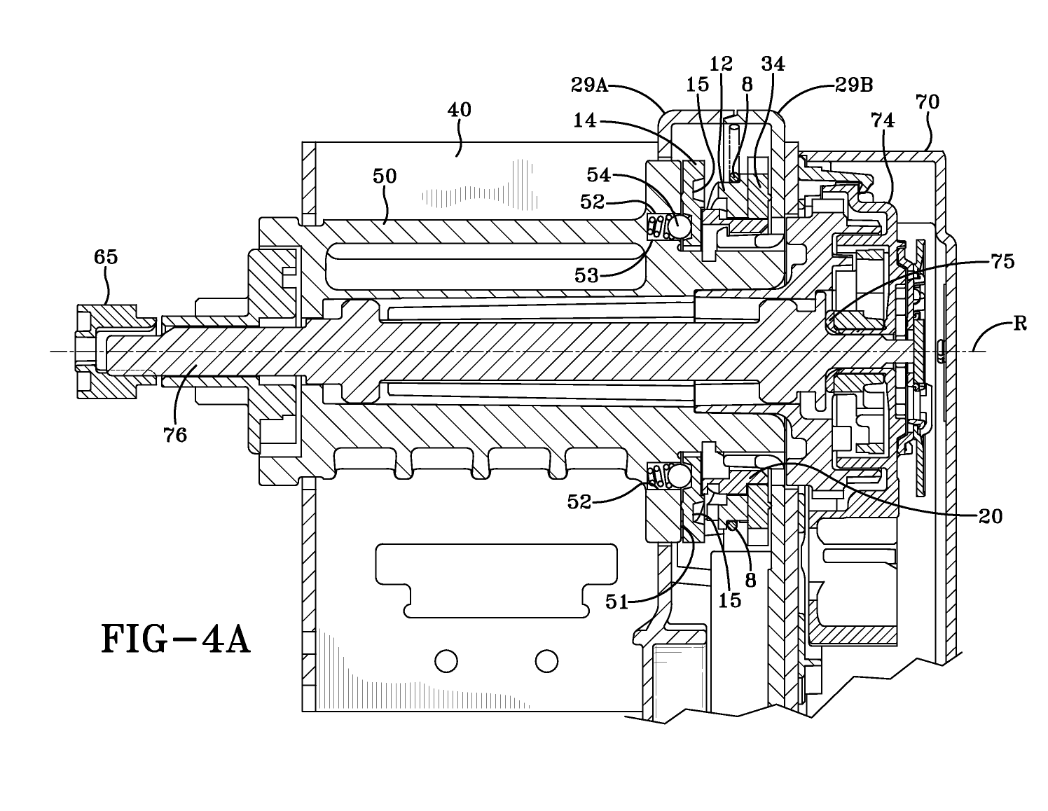

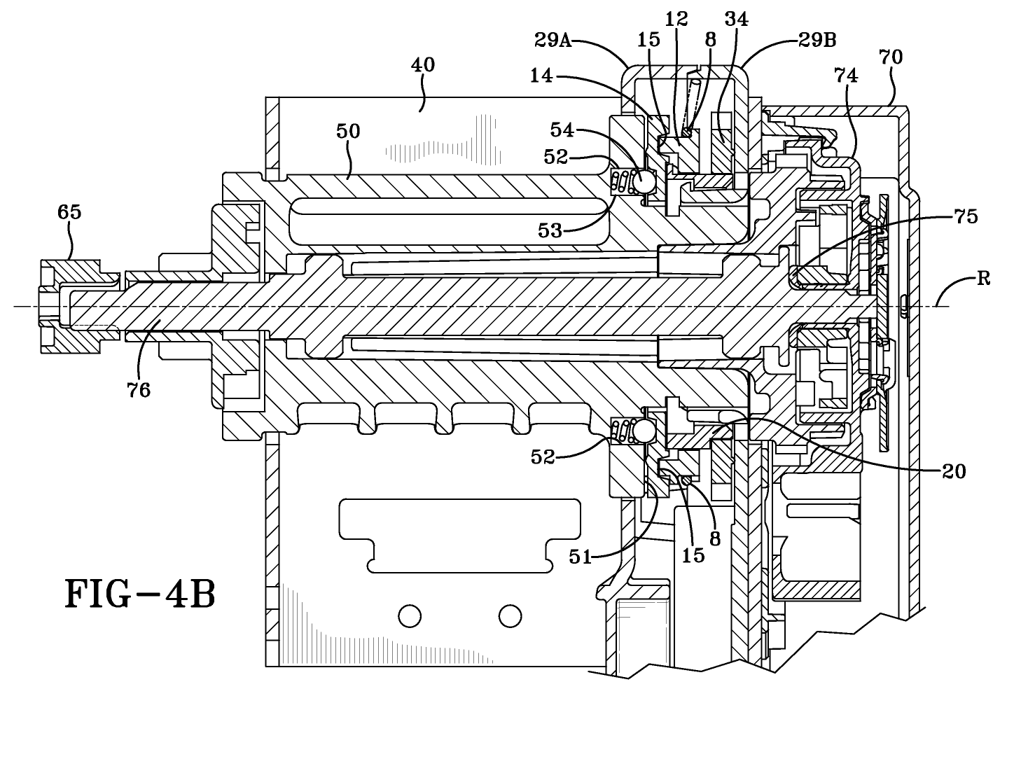

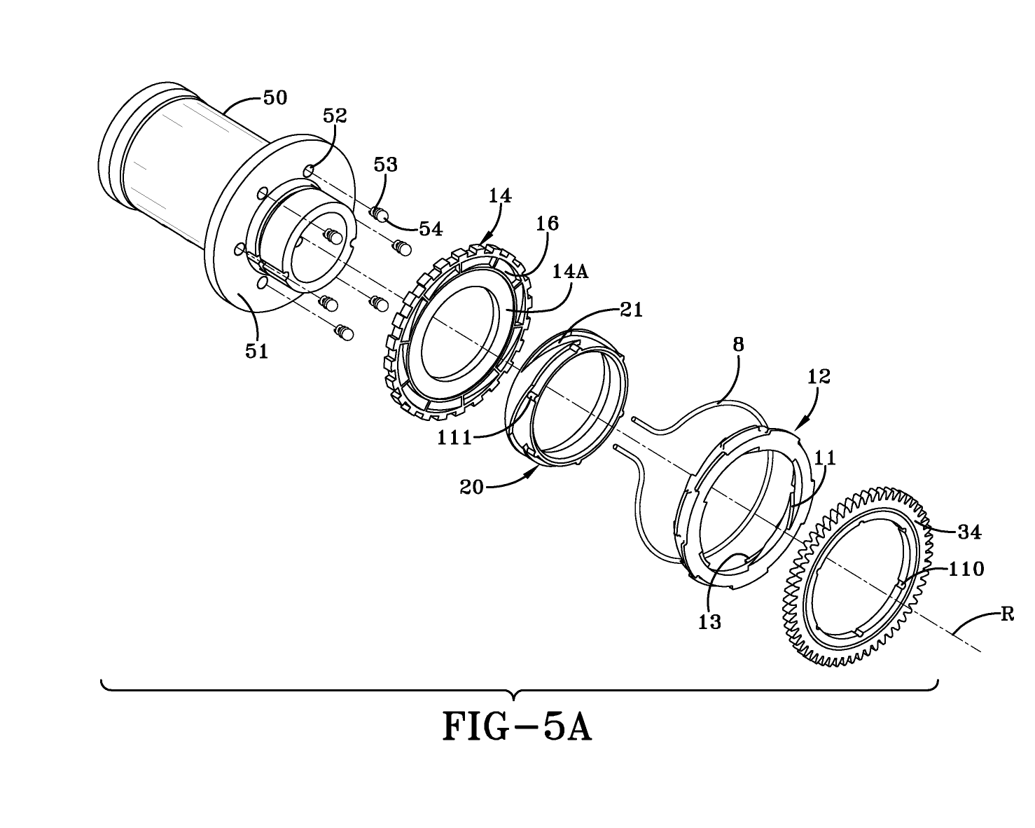

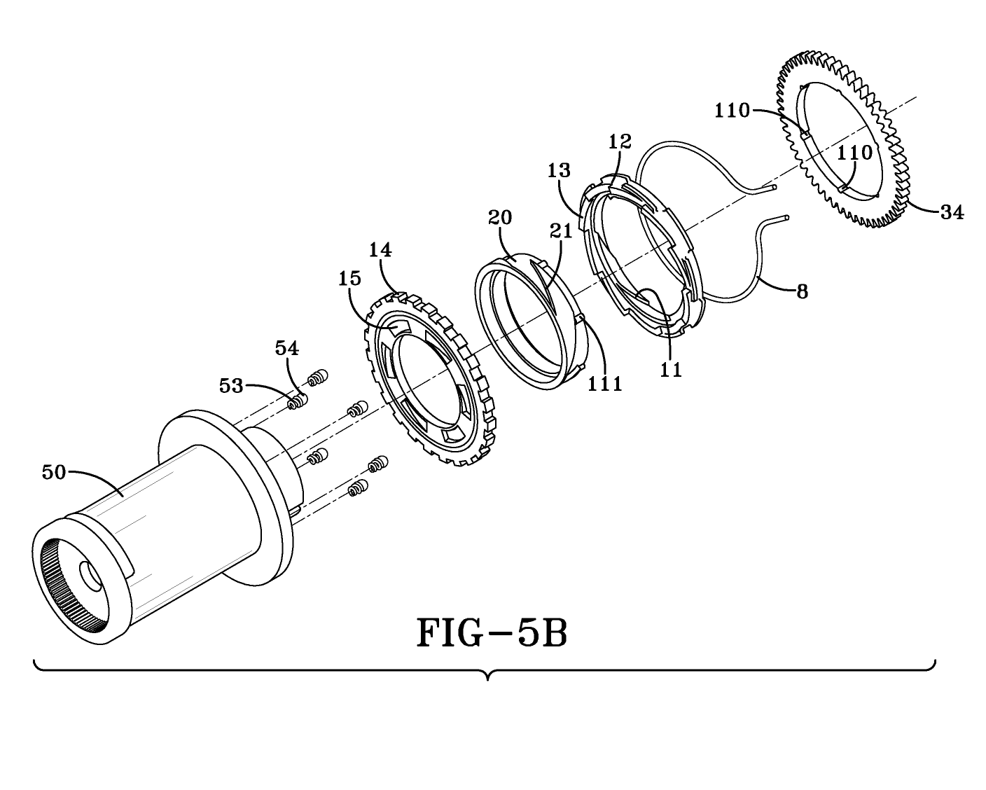

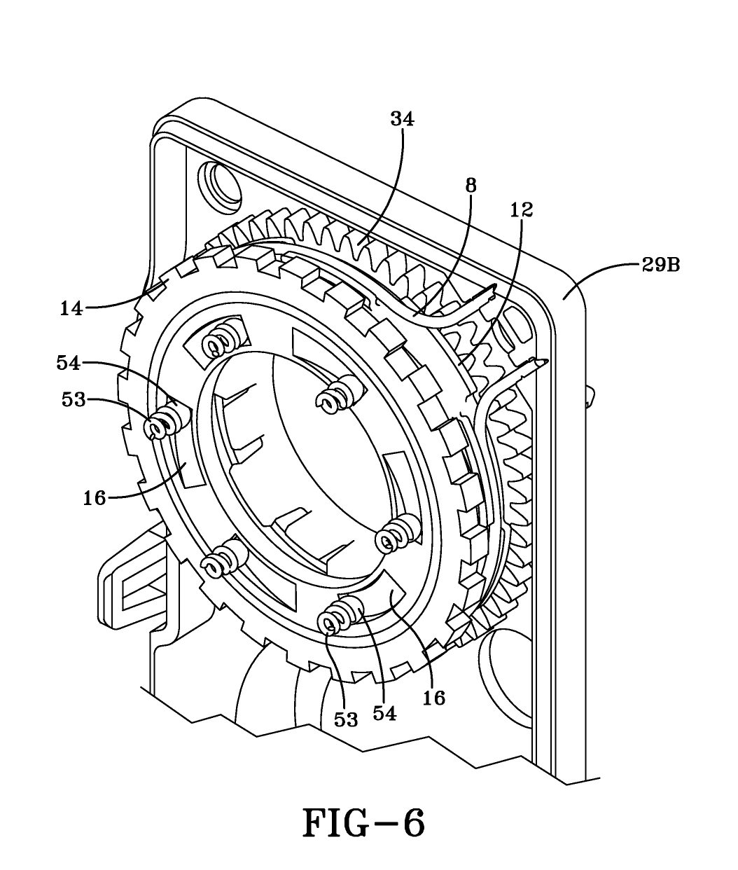

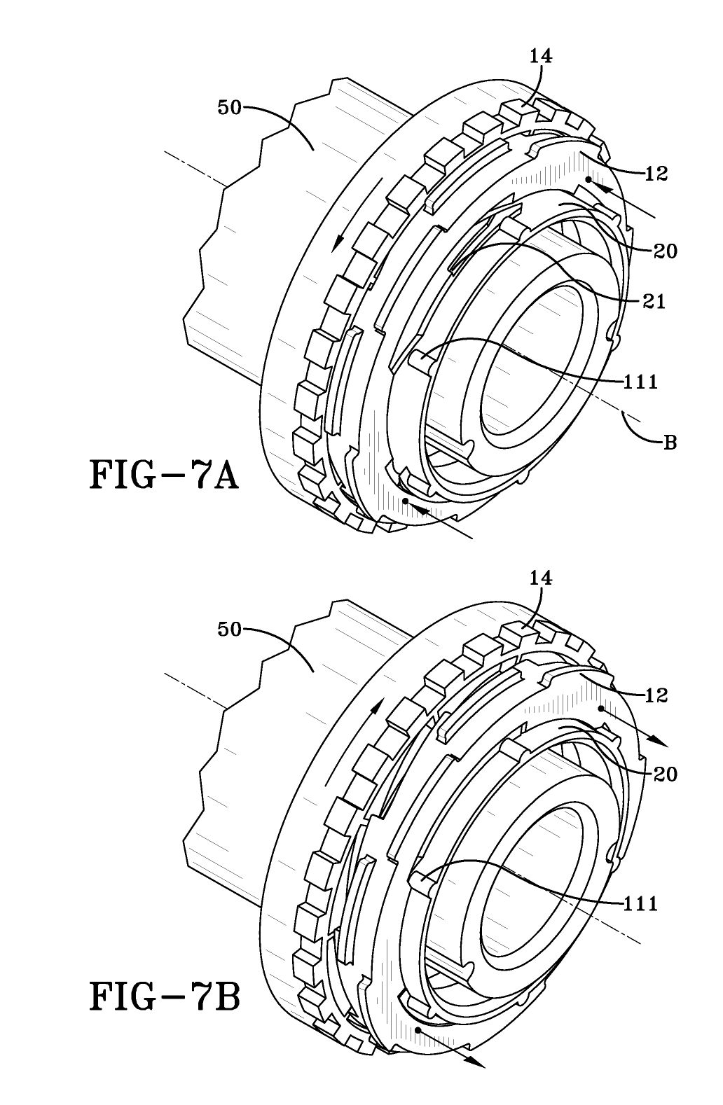

As shown in FIGS. 2B and 3, one of the unique features of the present invention is the use of a motor 30 attached to a clutch means 10. The motor 30 is attached to the lower portion of the seat belt retractor 100 and is encased in a motor sleeve 31. The motor is also attached to the clutch means 10 which is entirely encased within a first clutch cover portion 29A and a mating second clutch cover portion 29B. As illustrated the drive axle 32 of the motor 30 is attached to a pinion gear 33 which drives a plurality of cluster and idle gears 35, 36, 37 each cluster gear 36 and idle gears 35, 37 are mounted and physically attached through the cover portions 29A to the frame side 42 using cluster and idler pins 38 as illustrated. The pins 38 are then threadingly engaged using the screws 39 as illustrated. These gears 33, 35, 36, 37 connected directly to the motor 30 are connected to a ring gear 34 of the clutch means 10 which is coaxially aligned with the axis of rotation R (shown in FIGS. 2A, 2B, 3 and 4A) of the spool 50. As further illustrated in FIG. 2B as well as in FIGS. 5A and 5B, the ring gear 34 has a plurality of recesses 110 on an inner diameter into which protrusions 111 on a tubular shaped cylindrical ring 20 is pressed, this ring 20 has an outside diameter with a helix type of thread 21 shown on its outer surface. Attached to this ring 20 is a clutch plate 12 having an inside diameter with a complimentary threaded helix thread 11 that mates to the ring 20 in such a fashion that as the ring gear 34 is turned by the motion of the motor 30, the clutch plate 12 can move along and be moved by the helix thread 21. This is made possible by the use of a drag wire 8 (shown in FIGS. 3, 4A and 4B) wrapped around the outer circumference of the clutch plate 12 as shown in FIG. 6. The drag wire 8 is a spring type device that provides frictional drag on the clutch plate 12. When assembled into the clutch cover portions 29A and 29B as shown in FIG. 4A, the drag wire 8 is not free to rotate as the ring gear 34 and ring 20 rotate, accordingly, the clutch plate 12 will be driven inwardly absent any rotational motion until it approaches the end of the threaded helix portion 21 of the ring 20 in which fashion it will then initiate an increased torsional force which overcomes the drag friction on the drag wire 8 and enables the clutch plate 12 to rotate freely inside the drag wire 8. As a portion of the drag wire 8 is being moved linearly inward and by the forward motion of the motor 30 an over-clutch 14 is engaged as shown in FIG. 4B. The over-clutch 14 as illustrated has a plurality of recesses 16 shown in FIG. 5A on a first side 14A of the over-clutch 14, as the clutch plate 12 approaches it, teeth 13 on the clutch plate 12 engage these recesses 16 in such a fashion that the clutch plate 12 continues to move towards the spool 50 until the teeth 13 of the clutch plate 12 are fully engaged within the arcuately elongated recesses 15 of the over-clutch 14, as the over-clutch 14 is then rotated along with the spool 50 by the clutch plate 12. As can be seen in FIGS. 5B and 3, the spool 50 has an end 51 with a plurality of holes 52 adapted to accept an over-clutch springs 53 in each hole location 52 and one of a plurality of balls 54, preferably ball bearings 54 is positioned between the over-clutch spring 53 and the over-clutch 14. On one side of the over-clutch 14 there are a plurality of recesses 15 correspondingly aligned with the holes 52 in the end of the spool 50. Upon assembly to the spool 50 the over-clutch 14 has these recesses 16 come into alignment with the holes 52 wherein the spring loaded ball bearings 54 are moved inwardly into the recesses 15 on the over-clutch 14 creating a locking engagement between the over-clutch 14, and the spool 50. The over-clutch 14 being held against the spool 50 by a retainer clip (not shown). As illustrated in FIGS. 4B and 7A, when the spool 50 is rotated by the movement of the drive motor 30 in a direction to affect seat belt retraction, which is accomplished by rotation of the gears 33, 35, 36, 37 being connected to the ring gear 34 causes the clutch plate 12 to move linearly inward and engage the over-clutch 14 which in turn being fixed to the spool 50 creates the motion necessary to initiate rotation of the spool 50 to tighten the seat belt. The activation of the motor 30 can occur in many situations including non-crash situations to retighten a loose seat belt about an occupant or when a sensor indicates that a crash appears imminent which causes a signal to be sent to the electronic control unit 120 to activate the motor 30. In such a condition the seat belt will pretighten to ensure that the occupant is in a safe position and properly secured prior to impact. Should a collision occur which may be sensed by another sensor, the pretensioner mechanism 80 will activate to cause a significant increase in pretension forces to occur further driving the spool 50. However, in many occurrences the use of a motor 30 is provided in the event that an incipient crash (rapid vehicle deceleration) is sensed wherein the prepositioning of the seat belt and the occupant is desirable. Therein comes the use of the electric motor 30 and the clutch means 10 according to the present invention. What is unique about this device 100 is that motions are all incurred and engagement of the spool 50 occurs through a linear movement that is coaxial with the axis of rotation of the spool 50 which means that the clutch plate 12 can engage the spool 50 through the over-clutch 14 in such a fashion that it creates a secure locking system that is independent of the other mechanism throughout the retractor assembly 100. This is important in that loads and overloads of the fragile plastic components used throughout the mechanism can be avoided in that a direct linkage is created between the spool 50 and the clutch means 10 and gearing of the electric motor 30 are independent of the other mechanism. This ensures that the seat belt is capable of being pretensioned, by the pretensioner mechanism 80, without unduly loading any of the other components of the device 100. Secondarily by reversing the motor 30 as shown in FIG. 7B, the seat belt can be unwound and the clutch means 10 will revert back along the helix thread 21 of the ring 20, such that as the clutch plate 12 pulls back away from the spool 50 and the pre-attached over-clutch 14 which enables the entire motor-clutch mechanism to disengage from the spool 50. Once this occurs, the clutch means 10 is totally isolated from the normal operation of the retractor assembly in such a fashion that the electromechanical seat belt retractor assembly can operate as a conventional seat belt retractor without any drag or resistance created by the motor or clutch means 10. This is quite useful in ensuring that none of the mechanical systems that are normally used within a seat belt retractor assembly need to be modified for the incorporation of the motorized clutch means 10. This ensures that there is no additional drag caused by the clutch 10 which is provided without interfering with the normal operation of the seat belt retractor assembly. What is particularly unique about the motor initiated, linear movement of the clutch means 10 is that the entire clutch means can be positioned in a very nominal amount of space. As shown, the entire clutch means 10 is located inside the side 42 of the seat belt frame 40 and the mechanical weight sensing mechanisms are located inside the dust cover 70 that are normally attached to such a retractor device. This means that the entire clutch means 10 is provided in a very compact and efficient assembly occupying a very limited amount of space which is extremely important when providing seat belt retractors with this level of performance capability or complexity.

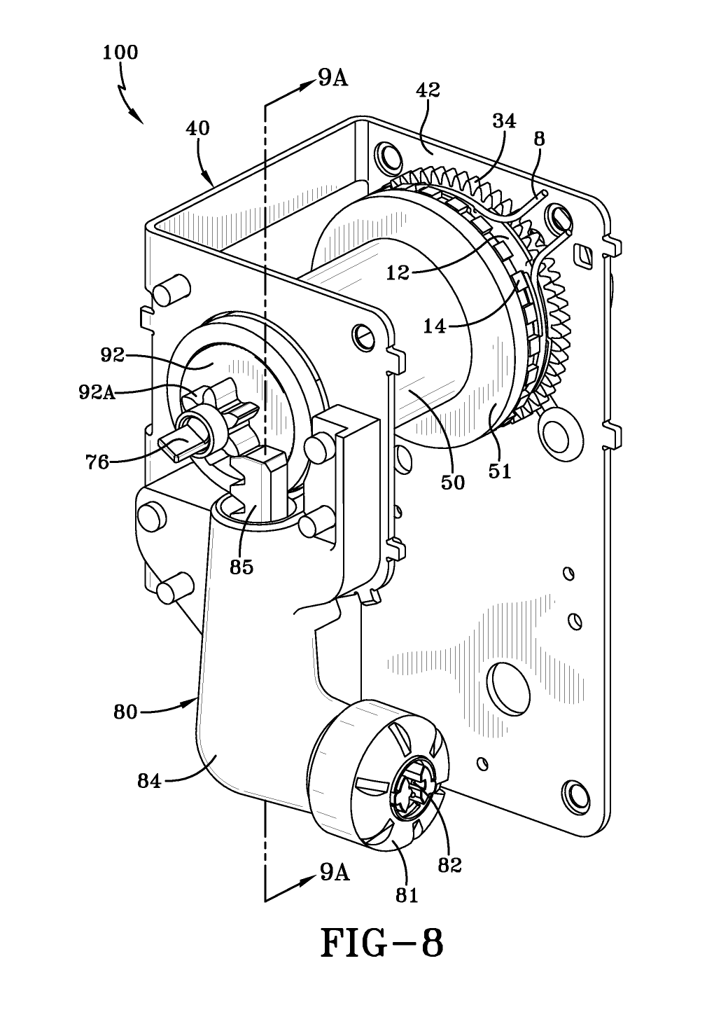

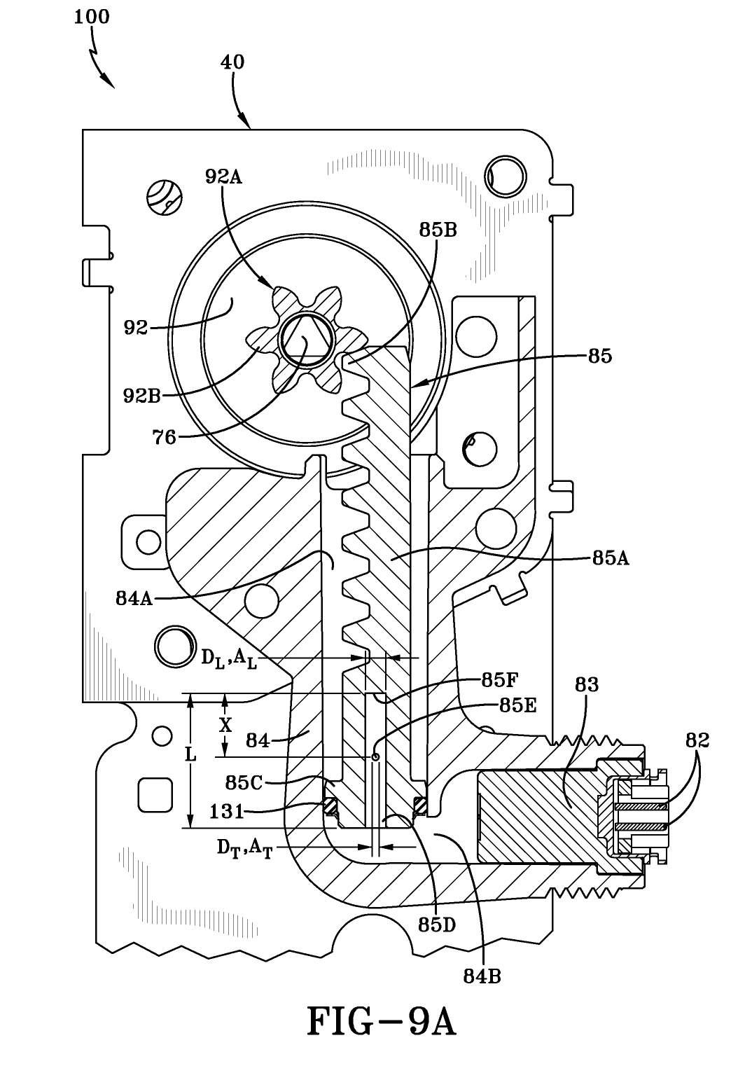

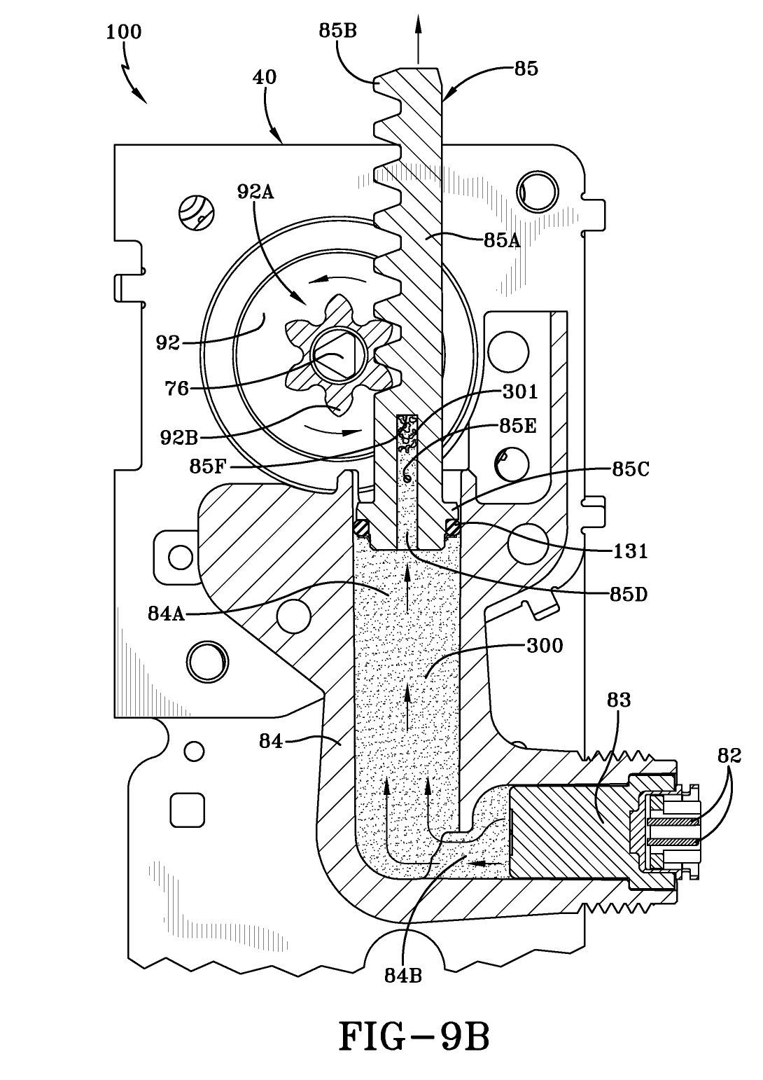

With reference to the pretensioner device, attention is called to FIGS. 8, 9A and 9B. In FIG. 8, the pretensioner mechanism 80 is shown attached to the frame 40 of the seat belt retractor 100.

The pretensioner mechanism 80 has a cap 81 threadingly attached. The cap 81 has an opening exposing a shorting clip 82 to which a wiring harness (not shown) can be attached. The shorting clip 82 is attached to a pyrotechnic gas generator device 83 that includes a propellant charge and an igniter squib as shown in FIG. 9A. The gas generator device 83 is shown stored in a transverse chamber portion 84B of the manifold housing 84. In a longitudinal chamber portion 84A is housed a piston 85. The piston 85 has an enlarged flanged end portion 85C with an O ring type seal 131 for air tightly engaging the walls of the longitudinal chamber portion 84A. A rack portion 85A extends outwardly from the flanged end portion 85C. On one side of the rack portion 85A there are a plurality of gear teeth 85B. The gear teeth 85B engage pinion gear 92A which has gear teeth 92B that intermesh with the teeth 85B of the rack 85A when the pretensioner device is activated to move the piston 85 up the longitudinal chamber 84A causing the pinion gear 92A to rotate moving the spool 50 to take up any belt slack. As shown in the opening through the pinion gear 92A is the end of energy absorbing device such as torsion bar 76.

As further shown in FIG. 9A is a first large longitudinal extending passageway 85D that extends partially through the lower portions of the piston 85. This passageway extends a substantial distance into the rack portion 85A to a closed end 85F. The length of the passageway 85D is at least 20 mm and the cross sectional area A_{L} is generally uniform along the length L and is preferably at least 12.6 mm², as shown the cross section is circular having a diameter D_{L} of at least 4 mm.

A second passageway 85E intercepts with the first longitudinal passageway 85D. The location of the passageway 85E may vary relative to the length of first longitudinal passageway 85D. As illustrated the intersection point is approximately halfway up the length of the first longitudinal passageway 85D. The passageway 85E is an exhaust passageway and is open on at least one end to the chamber 84A such that gasses produced by the pyrotechnic element can pass to reduce the gas pressure in chamber 84B. As shown the transverse vent 85E can pass through one or both sides of the rack 85A and the passageway 85E is very small in comparison to the cross-sectional area of the first passageway 85D. The total area A_{T} of one or two of the second passageway is less than 7% of the area A_{L} of the first passageway 85D. As shown the cross-sectional area A_{T} is 0.8 mm² and is of a circular cross section having a diameter D_{T} of about 1 mm when only one exhaust vent is used. The diameter D_{T} is less than 1 mm when two such passageways 85E are employed.

With reference to FIG. 9B when the pyrotechnic gas generator 83 is ignited the gas 300 pushes the piston 85 thrusting it upward into the chamber 84A causing the pinion gear 92A to rotate the spool 50 removing the web slack. Upon ignition of the propellant in addition to gas 300 from the propellant, the small amount of solid debris 301 is created. This solid debris is propelled up into the first longitudinal passage 85D moving very rapidly past the transverse passage 85E and impacting in the end 85F of the first passageway 85D creating turbulence. This debris 301 is lodged in the end 85F of the first passageway 85D at least during the time that gas is being generated by the pyrotechnic element 83 and as such the debris 301 tend not to block or impede the gas venting through the second transverse passageway 85E. The continued build up of gas pressure creates a blocking action holding the debris 301 against the end 85F as the gas 300 vents through the side or transverse passageway 85E. Thus by providing a sufficiently large holding space in the volume of 85D beyond the transverse passageway 85E, all the debris 301 are entrapped by the onflow of gas 300 trying to leave through the second transverse passageway 85E. As shown in FIG. 9A, the gas venting second passageway 85E is located a distance X of at least 10 mm from the closed end 85F. Similarly the diameter of the first passageway 85D is at least 4 times greater than the diameter of the second transverse passageway 85E, resulting in an area difference wherein the area A_{L} is preferably about 10 times greater than the total area A_{T}.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. An electromechanical seat belt retractor comprising:
a seat belt retractor assembly having a spool rotationally moveable about an axis of rotation for winding and unwinding a seat belt;
a motor for selectively rotating the spool;
a clutch means driven by the motor through one or more gears; the clutch means being coaxially aligned with the axis of rotation of the spool and linearly spaced from the spool; and
wherein upon a forward actuation of the motor a clutch plate of the clutch means linearly move to engage the spool or to engage an over-clutch pre-attached to the spool coupling to the spool and thereafter rotating the spool about the axis to initiate winding of the seat belt.

2. The electromechanical seat belt retractor of claim 1 wherein after the clutch plate or the clutch plate and over clutch in combination engage the spool, a reversal of the motor moves the clutch plate component linearly away from the spool disengaging the spool.

3. The electromechanical seat belt retractor of claim 1 further comprises;
a frame for holding the spool; and
a clutch cover housing attached to an end of the frame, having an opening to allow an end of the spool to be engaged by the clutch means.

4. The electromechanical seat belt retractor of claim 3 wherein the clutch cover housing has an internal surface; and
the clutch means further comprises a friction drag spring partially encircling an outer surface of the clutch plate and in contact with the internal surface of the clutch cover housing to prevent rotational movement of the clutch plate until a predetermined force or torque level is exceeded as the spool is engaged.

5. The electromechanical seat belt retractor of claim 3 wherein the cutch means further comprises:
a ring gear coaxially aligned with the axis of rotation of the spool;
a ring cylinder attached to the ring gear, the ring cylinder having an outer diametrical surface with a helical drive thread; and wherein
the clutch plate has a complimentary helical drive thread on an inner diametrical surface, the clutch plate being mounted onto the ring cylinder and linearly moved by a rotation of the ring gear.

6. The electromechanical seat belt retractor of claim 5 wherein the clutch means further comprises:
an over-clutch, the over-clutch being attached to an end of the spool and positioned between the end of the spool and the clutch plate, the over-clutch has a plurality of recesses on a first side facing the clutch plate; and
wherein the clutch plate has a plurality of pivotable teeth of a side of the clutch plate facing the over-clutch for interlockingly engaging the plurality of recesses.

7. The electromechanical seat belt retractor of claim 6 wherein the over-clutch has a second side spaced from and facing an end of the spool, the second side has a plurality of spherical recesses; and
wherein the end of the spool has a plurality of holes, each hole being oriented to align with the spherical recesses of the over-clutch, each hole holding a spring and a ball wherein the over-clutch is pre-attached to the end of the spool compresses the ball and spring and upon further rotational movement of the ring gear the clutch plate overcomes the drag spring force and rotates causing the over-clutch to rotate due to the engagement of the teeth and recesses and the balls being seated into the recesses of the over-clutch causing the spool to rotate.

8. The electromechanical seat belt retractor of claim 7 wherein a reversal of the motor causes the clutch plate to move linearly away from the spool and the over-clutch and disengages the spool such that the clutch means does not interact with the seat belt movement.

9. The electromechanical seat belt retractor of claim 1 further comprises:
a pre-loaded spring assembly for biasing the seat belt in the normally wound position, the pre-loaded spring assembly being connected to an end of the spool to provide rotational movement of the spool.

10. The electromechanical seat belt retractor of claim 1 further comprises:
a pretensioner assembly connected to an end of the retractor to drive the spool in a rapid windup in the event of a crash.

11. The electromechanical seat belt retractor of claim 1 further comprises:
a mechanical spool rotation locking device including a torsion bar, an inertial sensor and means for locking the spool from an unwinding rotation.

12. The electromechanical seat belt retractor comprises:
a seat belt retractor assembly having a spool rotationally moveable about an axis of rotation for winding and unwinding a seat belt;
a motor for selectively rotating the spool;
a Bendix type clutch driven by the motor to linearly engage the spool to initiate a winding rotation of the spool.

13. The electromechanical seat belt retractor of claim 12 wherein a reverse motion of the motor disengages the Bendix type clutch from the spool.

14. An electromechanical seat belt retractor comprising:
a retractor frame;
a spool for winding up a seat belt attached to the frame;
a motor configured to generate rotational torque for rotating the spool;
one or more gears coupled to the motor for generating rotational torque; one gear being connected to a tubular ring with a helical thread; the gear and tubular ring being coaxially aligned with the spool;
a clutch plate being located onto the tubular ring and linearly moveable along the helical thread relative to the axis of rotation of the spool;
a friction drag means encircling at least a portion of the outer surface of the clutch plate and to prevent rotational motion of the clutch plate;
an over-clutch having a first side with a plurality of recesses for receiving a plurality of teeth on a side of the clutch plate, the over-clutch being spaced from the clutch plate until the motor moves in a forward direction; and
a spring loaded spool locking means which engages and locks into one or more locking recesses on a second side of the over clutch to lock the spool into a motor driven belt wind up rotation by the linear movement of the clutch plate into the over-clutch which is in locked engagement to the spool.
